(19) United States
(12) Patent Application Publication
(10) Pub. No.: US 2011/0221182 A1
(43) Pub. Date: Sep. 15, 2011

(54) NOTEBOOK FOR MARCHING BANDS AND DESIGN METHOD OF MARCHING BANDS

(76) Inventor: Akihiro OOKUBO, Yokohama-shi (JP)

(21) Appl. No.: 13/044,154

(22) Filed: Mar. 9, 2011

(30) Foreign Application Priority Data
Mar. 10, 2010 (JP) 2010-53311

(51) Int. Cl. B42D 1/00

(52) U.S. Cl. 281/38

(57) ABSTRACT

[Subject]

To make carrying and reading information including each member's position and action are easy about the performance and acting of marching bands, and to raise the completeness of the performance and acting of the marching band.

[Means for Solution]

a notebook for the marching bands which consists of a plurality of separately refills 210 printed same entry columns, and the holder 30 for holding refill 20 of several sheets collectively, wherein a musical piece entry column 211 for writing the musical piece, and a action entry column 212 for writing the shift of the action according to the musical piece written in the musical piece entry column 211 are printed on the separately refill 210.

### TECHNICAL FIELD

The present invention relates to a notebook for marching bands, and a design method of marching bands.

### BACKGROUND ART

Conventionally, the marching band is performed by members as group action with the musical piece briskly. As for this marching band, it is performed by the band arranged of the wind instrument, the percussion instrument, etc., with action constructing the line and marching. As the performance of this marching band, they act the drill formation at the fields, or at the floors in such a indoor stadium, etc.

About the marching band, the drill formation is spread by moving of several members to next position from a position according to the musical piece, an unification feeling and performance power as the whole band are important. For that purpose, the member's individual skill and also every members' teamwork are necessary, and in order to raise the completeness of the performance and performance of the marching band, each member is practicing every day.

By the way, in the drill formation, since their position and action are arranged for every member, each member needs to write down the information of their position and action of the performance and acting in their note, or their memo pad, etc. And they often hang the notebook to their shoulder by a strap, and they were confirming their position and their action by reading their note during practice (for example, patent documents 1).

### PRIOR ART DOCUMENT

### Patent Documents

[Patent documents 1]

Japanese utility model registration No. 3084214

### SUMMARY OF THE INVENTION

### Problem(s) to be Solved by the Invention

However, as mentioned above, when the marching bands are performed, each member's position, moving trucking, etc. are changing every moment with proceeding of the musical piece. For that reason, in the past, each member had to work to summarize information about the self positions, action with the musical piece, and information about the whole band, such as the drill formation in the note, the job was so complicated. And if the information wasn't arranged accurately and wasn't written down, at the stage field, reading the information was difficult.

In order to solve the problem as described above, it is an object of the present invention to provide a notebook for the marching bands and the design method of the marching bands that the completeness of performance of the marching band can be advanced by looking up efficiently the information, including each one of positions, action, etc., and reading it according to the musical piece, in practice such as the drill formation which the marching band performs.

### Means for Solving the Problem

In order to accomplish the object as described above, the present invention provides a notebook used for the marching bands in which several members take group action with music comprising: separately refills consists of one or more sheets printed entry columns; musical piece entry columns for writing down musical pieces, and printed on the separately refills; action entry columns for writing down shifts of the action with the musical pieces written in the musical piece entry columns, and printed in the same field as the musical piece entry column on the separately refills; and a holder for holding the separately refills.

In according with the present invention, since the musical piece entry column for writing down the musical piece, and the action entry column for writing down the shift of the action according to the musical piece are printed by the same field on the refill, each member can arrange and write down the information including the self position, moving truck, etc. with the musical piece. In addition, according to the present invention, since a plurality of separately refills can be carried collectively, each members can look up and read efficiently the information including their position, moving truck, etc. with the musical piece.

Preferably, in accordance with the above invention, the notebook comprising further, an overview refill for printing overview entry columns, in order to combine and to write the shift of the action written to several sheets of the separately refill. In this case, since each member can understand the shift of total action easily, he can grasp easily shifts of his action in every part of the musical piece, and it will be possible to raise the completeness of the drill in the marching bands.

Preferably, in accordance with the above invention, the notebook comprising further, a binder part opened and closed as a booklet, wherein the binder part is opened and closed by the bent part as a pine, the holder part is arranged at this bent part, the shoulder strap is connected to the spine removable. In this case, it can summarize a plurality of refill to the binder as a booklet easily to the one notebook with the holder which holds a plurality of refill collectively. The member can have the information easily in practice with the strap of the binder, the member can check the self action with the musical piece immediately by opening the binder. Since the present invention is the binder-type notebook, replacement of refill is easy, for example, even if it is the case where some drills are changed, easily according to it by substituting only the separately refill.

Further, Preferably, in accordance with the above invention, the notebook comprising further, a marking plate as a hard plate removable to the holder part, wherein guide grooves are engraved on the both sides or one side of the hard plate. In this case, each member can create marking for pointing at the self position simply and quickly by sticking the sticky tape on the marking plate, and carving it along the guide groove by the cutter etc. Since the tool for making the mark and the refill for writing the information of the action shift with the musical piece are summarized in the one holder, it will be easy for each member to manage the tools required for the marching band unitary.

In accordance with the other invention, a design method of the marching band that several members take group action with music comprising,

(1) a step for writing down musical pieces to musical piece entry columns on separately refills, and for writing down shifts of the action with the musical pieces written in the musical piece entry columns to action entry columns printed in the same field as the musical piece entry column on the separately refills, and for holding separately refills to a holder,

(2) a step for posting the sticky tape in order to cross to guide grooves which are engraved on the both sides or one side of a marking plate as a hard plate removable to the holder, a step for writing down the information about the action written to the separately refills, to the sticky tape on the marking plate according to the guide groove,

(3) a step for making markings by carving the sticky tape on the marking plate along the guide groove, and

(4) a step pointing the marking in according to the shifts of the action written down to the separately refills.

According to this invention, since each member can write the information in the musical piece entry column and the action entry column, and each member can make simply marking written the information about the action on the separately refill by using the marking plate, can point them to the floor, in practice of the marching drill, each member can do practice and the stage show, checking the self position and action by marking. As a result, the completeness of the drill of the marching band can be raised.

### Effect of the Invention

As mentioned above, according to this invention, in the practice or the stage show of the drill formation as the marching band according to the musical piece, it is efficient to look the information of each member's position or action up, and to read it. As a result, it will be possible to raise the completion accuracy of drill acting as the marching bands.

### BRIEF DESCRIPTION OF THE DRAWINGS

[FIG. 1]

FIG. 1 is a perspective view showing the composition of the notebook for marching bands related to the embodiment.

[FIG. 2]

FIG. 2 is a top view showing the state where the notebook for the marching bands related to the embodiment was opened.

[FIG. 3]

FIG. 3 is a perspective view showing the composition of the pen storage sheet related to the embodiment.

[FIG. 4]

FIG. 4 is a perspective view showing the composition of the marking plate related to the embodiment.

[FIG. 5]

FIG. 5 is a explanatory view showing the action at the time of the marking creation related to the embodiment.

[FIG. 6]

FIG. 6 is a top view showing the separately refill related to the embodiment.

[FIG. 7]

FIG. 7 is a top view showing the overview refill related to the embodiment.

[FIG. 8]

FIG. 8 is a top view showing the identification information number written sheet related to the embodiment.

[FIG. 9]

FIG. 9 is a flowchart figure showing the designed method of the marching band related to the embodiment.

[FIG. 10]

FIG. 10 is an explanatory view showing the written example of the separately refill related to the embodiment.

### DESCRIPTION OF THE PREFERRED EMBODIMENTS

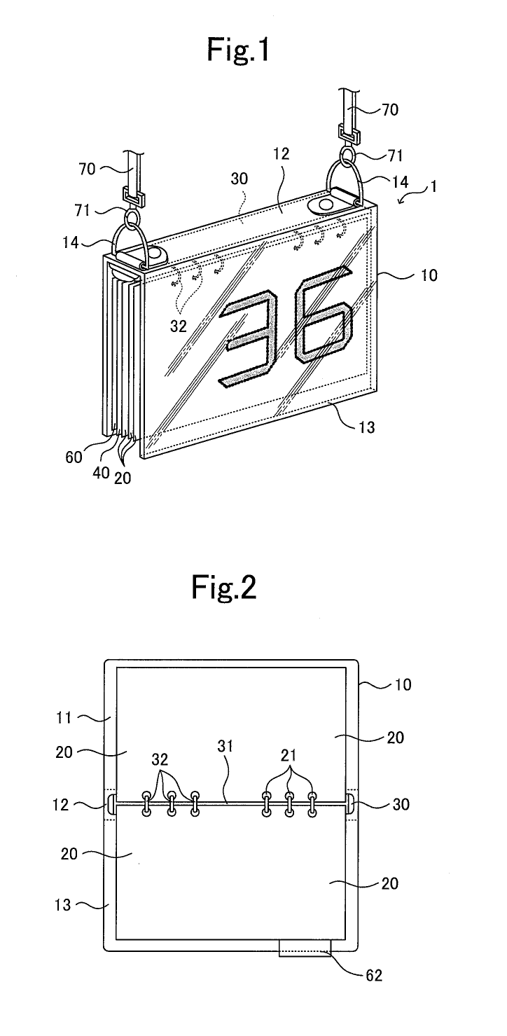

An embodiment of the present invention will be described with referring to the drawings as the following. FIG. 1 is a perspective view showing the composition of a notebook for the marching bands related to this embodiment. FIG. 2 is a top view showing the state where the notebook for the marching bands related to this embodiment was opened.

As shown in FIG. 1, the notebook 1 is used for the marching band in which several members take group action according to the proceeding of the musical piece, as for it, the holder 30 is attached to the spine of the binder 10 as a booklet, a plurality of refill 20, marking plates 40, and pen storage sheets 60 are held removable at the holder 30.

The binder 10 is a cover made of the one sheet of a hard material, such as the transparent or translucent acrylics or plastic, and consists of a front cover 11, a reverse cover 13, and a spine 12. In detail, as shown in FIG. 2, the binder 10 has a pair of parallel grooved folds 15 and 15 in the position separated from the center of the cover material to both directions, the binder 10 is opened and closed such as the booklet by folding the cover material with a pair of the folds 15 and 15. And the spine 12 is shaped in the binder 10 between the folds 15 and 15, the binder 10 consists of this spine 12, and the cover 11 and the reverse cover 13 of the both sides. The holder 30 is attached to the inside of the spine 12 as a bent part of that at the binder part 10.

Two rings as the suspending portions 14 and 14 are provided to the outside of the spine 12 of the both ends, a shoulder strap 70 is connected by these suspending portions 14 and 14 removable. This strap 70 has the hook 71 which can be detached and attached freely to the suspending portion 14, a length adjust parts (not shown) to adjust the length of the loop part hung to the shoulder is attached. These hooks 71 and length adjusting parts are able to make of the plastic, the hook 71 is attached to the binder 10 with the suspending portion 14, in order to change the length of the strap, from the attaching position of this hook 71 to a cuff position of the other end, length adjusting parts are in the state which can be slid freely, and are attached to the strap 70.

The holder 30 is arranged inside the spine 12, is an attachment component which holds a plurality of refill 20, marking plates 40, and pen storage sheets 60 collectively, and is shaped by the metallic members, such as stainless steel. The holder 30 has a pair of rings 32 stand out from the base 31 to the internal direction, this ring 32 is opened or closed by the springy of the spring provided inside the base 31 of the holder 30. With opening this ring member 32, the hole 21 of refill is inserted in, and refill is collectively and held by stopping the ring 32.

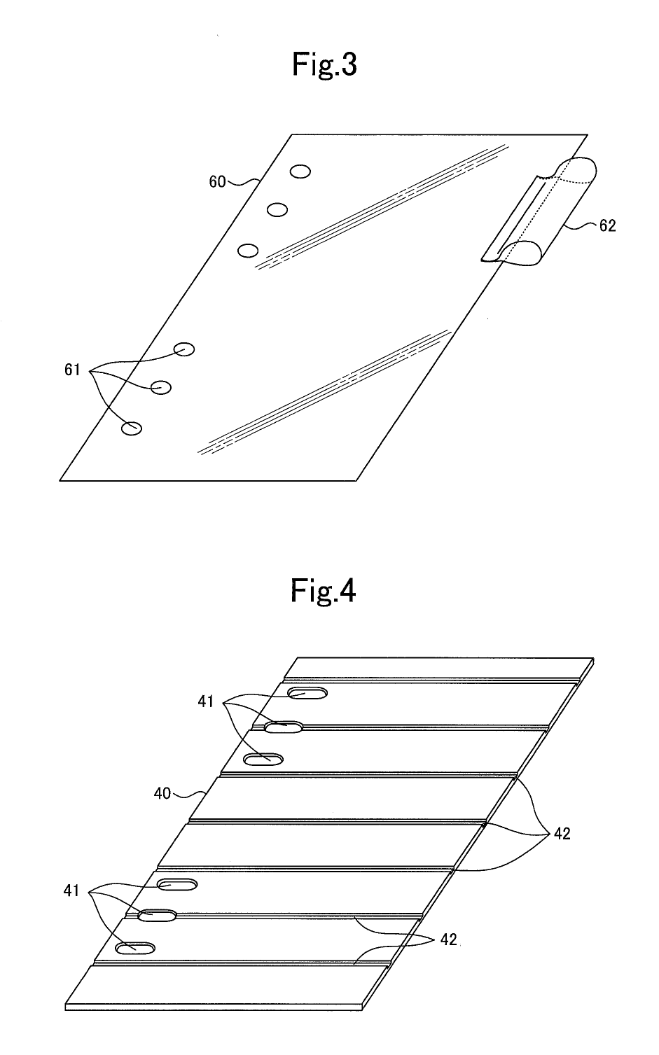

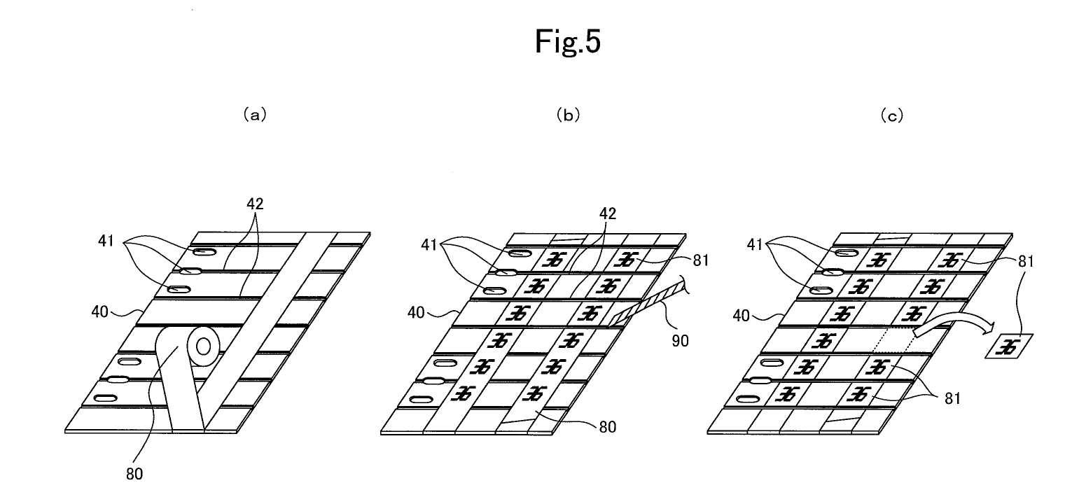

Next, each parts held at the holder part 30 are explained. FIG. 3 is the perspective view showing the composition of the pen storage sheet 60 related to this embodiment, FIG. 4 is the perspective view showing the composition of the marking plate 40 related to this embodiment, FIG. 5 is the explanatory view showing the action at the time of the marking creation related to this embodiment.

As shown in FIG. 3, the pen storage sheet 60 is shaped with the synthetic resins, such as the flexible transparent plastic and the vinyl, and is the sheet member for storing the pen. Two or more holes 61 for inserting a plurality of rings 32 in one end of the sheet are made up in the pen storage sheet 60, the pen storage part 62 of the shape of a cartridge penetrated vertical is added to the side face end of another side of that.

The marking plate 40 is refill for making and holding the marking sticker for checking each member's position, as shown in FIG. 4, it is the hard plates, such as stainless steel, it has the required interval in either sides or one side of the plate, and it is engraved with the guide groove 42. Two or more holes 41 according to a plurality of rings 32 are formed in one side also at the marking plate 40, by the ring 32 being inserted in these holes 41 of a plurality of, the marking plate 40 is held removable at the holder part 30. At this point, the marking sticker 81 is the sticker which fills in the character etc. and is stuck, it is made according to shift of the action written to refill 20, and the marking sticker 81 is installed in the floor or the field, marks of the marching can be pointed.

As the way of making the concrete marking sticker with using the marking plate 40, first, as shown in FIG. 5 (a), the sticky tapes 80, such as the vinyl tape, are stuck on the marking plate 40, for example, in order that it may cross perpendicularly with the guide groove 42.

Next, be shown in FIG. 5 (b), as the information about the action written to refill 20, for example, the member's identification number, the action order, etc. are written down in the sticky tape 80 on the marking plate 40 supported the interval of the guide groove 42.

Next, the sticky tape 80 on the marking plate 40 in which the information about action was written is carved by the cutter 90 along the groove 42, and the marking sticker 81 is made. As shown in FIG. 5 (c), the marking sticker 81 is each removed at the time of use, and is setting up in the given places, such as the floor or the field.

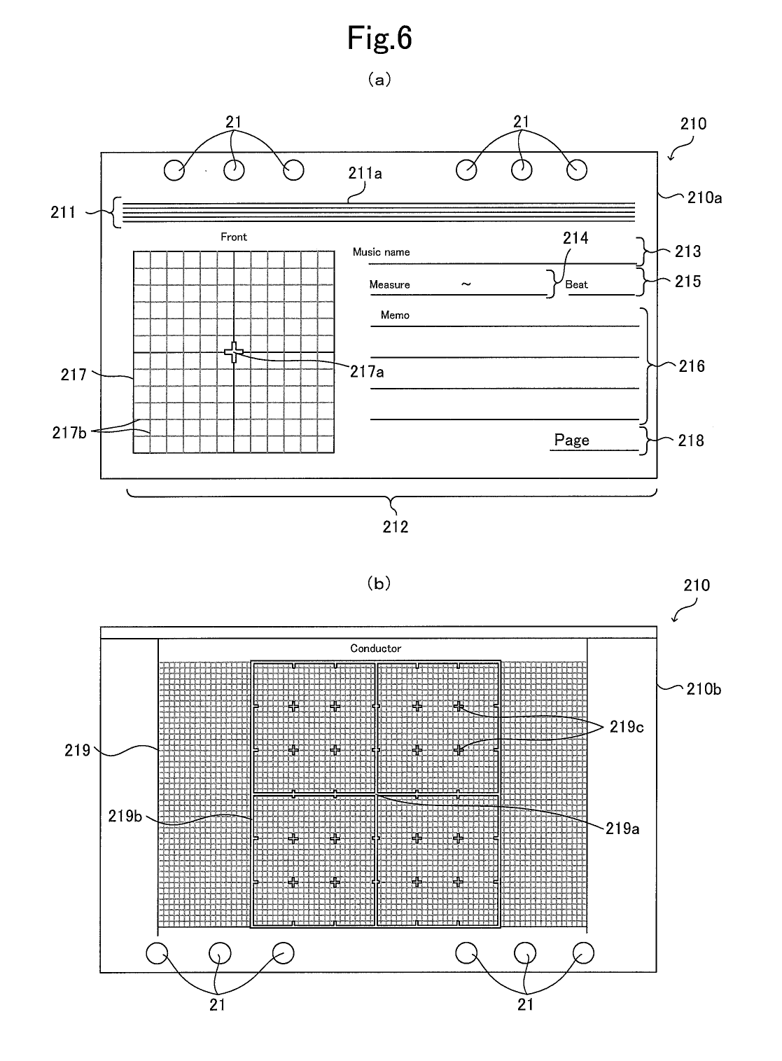

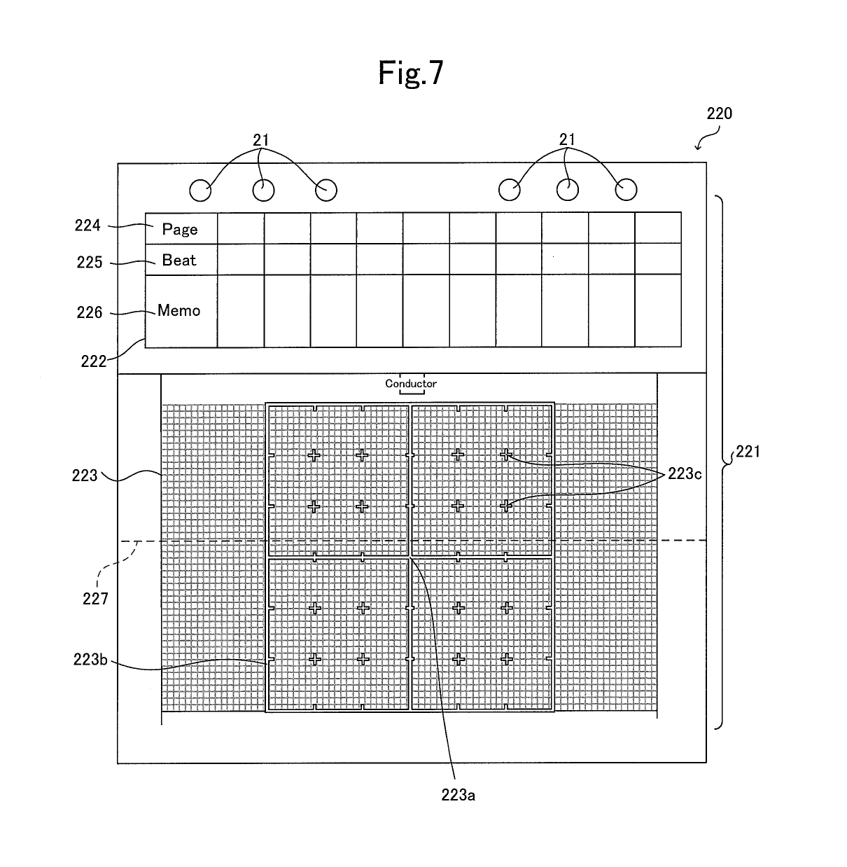

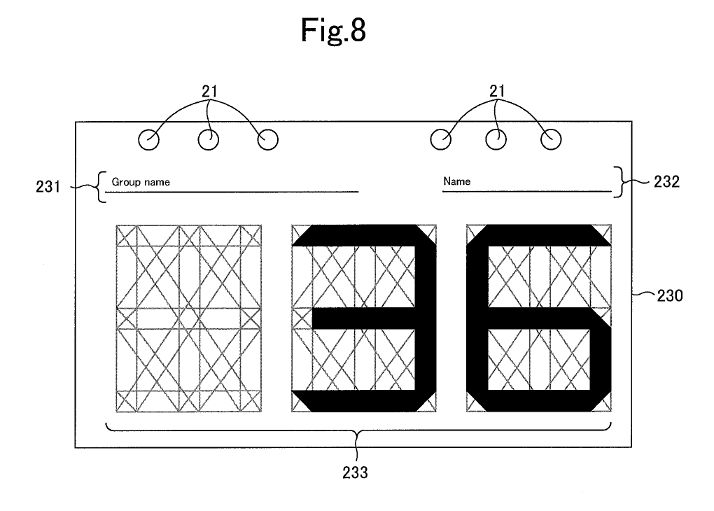

Next, refill 20 is explained. FIG. 6 is the top view showing the separately refill related to this embodiment, FIG. 7 is the top view showing the overview refill in this embodiment, FIG. 8 is the top view showing the identification information number written sheet related to this embodiment.

In this embodiment, refill 20 is a substitutable paper held in the binder type notebook 1 for the marching bands, columns for writing down the information about the performance and acting of the marching band is printed on it. The separately refill 210, the overview refill 220, and personal identification number written refill 230 are included in this refill 20. At this point, as for each refill, two or more holes 21 supported a plurality of rings 32 are formed in one side the same the above, by the ring 32 being inserted in these holes 21 of a plurality of, each refill is held removable at the holder 30.

Separately refill 210 is the replacement paper in which the same entry column was printed, the information about all the musical piece can be collected by the separately refill of two or more sheets being summarized in holder 30. Accordingly, as shown in FIGS. 6 (a) and (b), on separately refill 210, Entry columns are printed by both sides, musical piece entry columns 211 and action entry columns 212 are printed on the surface 210a, total coordinates figures 219 are printed on the rear face 210b.

In this embodiment, The musical piece entry column 211 is a column which is printed on the separately refill 210 and to write the partial contents of a musical piece. Specifically, as shown in FIG. 6 (a), musical scores 211a are printed and a member writes down notes with the musical piece to musical scores. The length of this musical score is 8 measures as a period of marching, for example. The action entry column 212 is a column which writes a shift of an action corresponding to a portion of a musical piece which was printed among separately refills by the same side as a musical piece entry column, and was written in the musical piece entry column 211. In detail, as shown in FIG. 6 (a), the action entry column 212 contains the action shift coordinates figure 217, the music name entry column 213, Measure entry column 214, the musical piece beat entry column 215, the memo column 216, the page column 218, etc.

The music name entry column 213 is a column for writing down a music name of the musical piece which performs and acts, and the measure entry column 214 is a column for writing down number of measures of a partial musical piece written in the musical piece entry column 211. The musical piece beat entry column 215 is a column for writing down the number of a rhythm of a partial musical piece written in the musical piece entry column 211. The memo column 216 is a column to write information about the performance and acting of the marching band, for example, to write the action of the marching drill, etc.

The action shift coordinates figure 217 is the rectangular-coordinates figure which writes the action of each member according to the musical piece written in the musical piece entry column 211, and moving trucking. In this action shift coordinates figure 217, the center point 217a of the coordinates figure is set as a starting position of the musical piece, and the length of the one grid of the grid 217b by the vertical axis and the horizontal axis is suited by the member's step. And the member writes down moving trucking concerned from the center point 217a according to the contents of the musical piece entered in the musical piece entry column.

On the other hand, as shown in FIG. 6 (b), the global coordinate figure 219 is printed on the rear face 210b of the separately refill 210. This global coordinate figure 219 is the rectangular-coordinates figure showing all the floor or field that carries the marching drill, and sets the center point 219a as a center of the floor or the field, and the length of the grid by the vertical axis and the horizontal axis suits to the member's step. And in this embodiment, the drill formation of all the band about the musical piece written on the surface 210a to this global coordinate figure 219 and the member's moving trucking in the overview are written. In the global coordinate figure 219, on the vertical axis and the horizontal axis, the line 219b and the mark 219c as a sign are drawn by the position distant from the center point 219a by one grid.

The overview refill 220 is a paper with which the total action entry column 221 was printed, and in the total action entry column 221, the shifts of the action written down to the separately refill of plural pieces, are integrated and entered. In this embodiment, as shown in FIG. 7, the separately refill information entry column 222 which writes the information about the musical piece written to the separately refill 210 for two or more minutes, and the global coordinate figure 223 which writes the moving trucking written in two or more minutes of the separately refill are printed by the total action entry column 221.

The individual refill page column 224 which writes the number of pages, the beat entry column 225 which writes the rhythm of the musical piece, and the memo column 226 which writes the remark of the action or others are contained in the separately refill information entry column 222.

The global coordinate figure 223 is the rectangular-coordinates figure showing all the floor or field that carries the marching drill, and the grid of the vertical axis and the horizontal axis suits to the member's step considering the center point 223a as a center of the floor or the field. And in this embodiment, the moving trucking written to this global coordinate figure 223 in two or more minutes of the separately refill 210 is written collectively. Moreover, also in this global coordinate figure 223, while the line 223b is indicated on the vertical axis and horizontal axis from the center section 223a of the floor, the mark 223c used as the sign is indicated on the grid of the constant interval.

And the musical piece data and behavior information for every part can be collected now, for example by writing in order the information written to this separately refill 210 to the separately refill information entry column 222 and the global coordinate figure 223. The overview refill 220 has the fold 227 in the transverse direction, and it can store it from the binder 10 of the notebook for the marching bands by bending the overview refill 220 along with this fold 227, without overflowing.

As shown in FIG. 8, the identification entry refill 230 is refill to write each member's personal identification information, in this embodiment, the corporate name entry column 231 which writes the corporate name, the name entry column 232 which writes the member's name, and the identification number entry column 233 which writes the member's identification number are printed on it.

In the identification number entry column 233, the grid is made by making four directions and the oblique line cross, by smearing away the selected grid, the symbol of the numbers 0-9, the alphabet, and others can be indicated now, and the 3-4 digits and the alphabet are written in this embodiment.

As shown in FIG. 1, the identification entry refill 230 is arranged at the last end by the side of the reverse cover 13, directs outside the side where the identification number was written, and is held at the 30 copies of holders so that it can carry out visible from the outside of the transparent or translucent binder 10. Thereby, for example, since the reverse cover 13 side is indicated towards outside when the member hangs the notebook to the shoulder and is practicing it, the conductor and other members can recognize the personal identification number visually, and can check each member.

(The Design Method of the Marching Band)

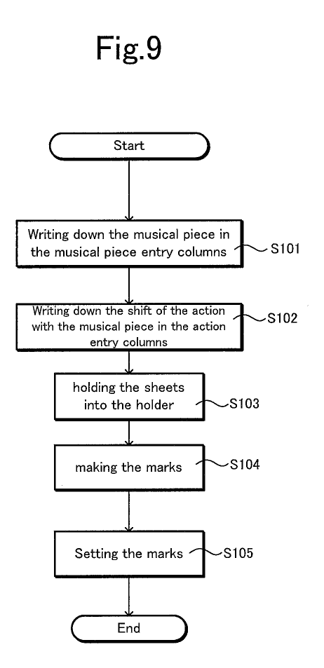

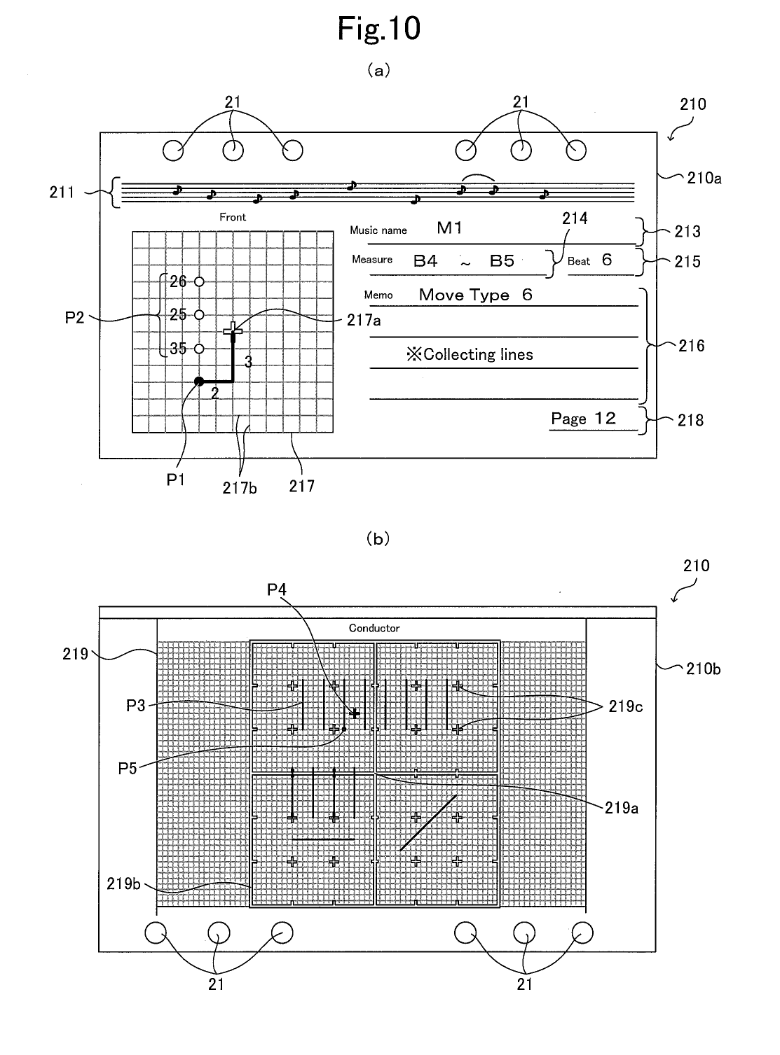

The design method of the marching band can be executed by using the notebook for the marching bands which has the above composition. The design method of the marching band concerning this embodiment is explained below. FIG. 9 is the flow chart figure showing the designed method of the marching band concerning this embodiment, FIG. 10 is the explanatory view showing the written example of the separately refill 210 concerning this embodiment.

As shown in FIG. 9, while each member enters the partial contents of the musical piece which performs or acts to each entry column on two or more separately refills 210 in the musical piece entry column (S101), the member writes the shift of the action corresponding to the musical piece entered at the musical piece entry column 211 in the action entry column 212 printed by the side same among the separately refills as the musical piece entry column 211 (S102).

In detail, as shown in FIG. 10 (a), the member enters some notes of the music name M1 in the musical piece entry column 211, enters the musical piece “M1” in the music name entry column 213, and enters “B4-B5” as a measure of the musical piece in Measure entry column 214, and enters the “sextuple time” as a beat number of the musical piece in the musical piece beat entry column 215, and enters the “Move type 6” which is the type of action at the time of movement in the memo column 216. While writing moving in the minus direction of the horizontal axis the two steps the three steps from the moving trucking 217a of this musical piece, for example, the center point, in the minus direction of the vertical axis to the action shift coordinates figure 217, the mark (P1) is attached to the position after movement. The personal identification number (No 25, No 26, No 35) of other members of the group to whom the member belongs is written (P2).

To the global coordinate figure 219 of the rear face 210b, as shown in FIG. 10 (b), the drill formation of all marching band is written (P3). Moreover, in this embodiment, in the rear face 210b, the state after movement of the drill formation written on the surface 210a is written, and the position (P4) before movement and the position (P5) after movement are further written in coordinates.

Moreover, in this embodiment, even though it wrote the state after movement of the drill formation written on the surface 210a in the global coordinate figure 219 of the rear face 210b, the present invention is not limited to this, easily, the member may write the state before movement of the drill formation written on the surface 210a, in order to manage the information.

And the member summarizes two or more separately refills 210, makes the ring 32 of the holder 30 insert in the hole 21 in accordance with the turn of the musical piece, and makes it hold in the holder 30 (S103). In this case, the member can also enter the information about the separately refill 210 for two or more minutes in each entry column of the overview refill 220.

Next, each member makes the marking sticker 81 which uses the marking plate 40, stands and acts as the marks, such as the position (S104).

In detail, in making of this marking, as shown in FIG. 5 (a), first, each member sticks the sticky tapes 80, such as the vinyl tape, on the marking plate 40, for example so that it may cross perpendicularly with the guide groove 42. It ranks second, as shown in FIG. 5 (b), the identification number as the information about the action written to the separately refill 210 is made to correspond to the interval of the guide groove, and the sticky tape 80 stuck on the marking plate 40 is filled in. Then the member carves the sticky tape 80 stuck on the marking plate 40 in cutter 90 grade along the guide groove 42, and makes the marking sticker 81. As shown in FIG. 5 (c), the marking sticker 81 is each removed at the time of use, and is stuck on the floor or the field (S105).

Thus, at the time of practice, the user suspends the strap 70, and he practices, hanging and carrying on the shoulder while he uses the notebook for the marching bands which held two or more refill 20 collectively and manages the information about the performance and acting of the marching band.

(The Operation and the Effect)

According to this embodiment described above, the musical piece entry column 211 to write the contents of the musical piece, and the action entry column 212 to write the shift of the action with the musical piece are printed on the same side of the separately refills 210 summarized in the notebook 1. Therefore, each member can write down at once the musical piece, and the position with the musical piece and the information about moving trucking in the musical piece entry column 211, 212. The member can hold the separately refill 210 for plural pieces collectively. As a result, the information including the position, moving trucking, etc., with the musical piece can be managed efficiently, and the completeness of the drill in the marching band can be raised. Further, in the case of the present embodiment, since the notebook 1 is made as the binder type, refills 20 are replaced easily, and even if the drill are changed partially, it is easy to respond to the changing by replacing selected separately refills 210.

In addition, in this present embodiment, the total action entry column 221 is printed on the overview refill 220, in this total action entry column 221, the shift of the action written to the separately refill 210 of several sheets can be combined and written. Therefore, each member can understand the shift of total action easily, he can grasp easily the shift of the action in every part of the musical piece, and can raise the completeness of the drill in the marching bands.

In addition, in the present embodiment, since the notebook 1 is provided with the binder 10 like the booklet and the holder 30 is arranged at the spine 12 of the binder 10, it can summarize a plurality of refill to the binder as a booklet easily to the one notebook with the holder which holds a plurality of refill collectively. Further, since the shoulder strap 70 is suspended removable by the spine 12 of the binder 10, during practice, the member can have the information easily with the strap 70 with the binder, the members can check his action according to the musical piece quickly, by opening their binder.

In the case of the present embodiment, the guide groove 42 is made up in both sides of the plate member, or one side at the holder 30 using the removable hard marking plate 40. Therefore, to carve the sticky tape 80 stuck on the side of the guide groove 42 of the plate member by the cutter 90 along the guide groove 42, each member can make the marking sticker 81 which marks its position simply and quickly. Since the tool for making the mark 81, and refill 20 for writing the information of the action shifts with the musical piece are summarized in the one holder 30, each member can manage the tools required for the marching band unitary.

### DESCRIPTION OF NOTATIONS

1—Notebook for marching bands

10—Binder

11—Front cover

12—Spine

13—Reverse cover

14—Suspending portion

15, 15—Folds

20—Refill

21, 41, 61—Spelling hole

30—Holder

31—Base

32—Ring

40—Marking plate

42—Guide groove

60—Pen storage sheet

62—Pen storage part

70—Shoulder strap

71—Hook

80—Sticky tape

81—Marking sticker

90—Cutter

201b—Rear face

210—Separately refill

210a—Surface

210b—Rear face

211—Musical piece entry column

211a—Musical score

212—Action entry column

213—Music name entry column

214—Measure entry column

215—Beat number entry column

216—Memo column

217—Action shift coordinates figure

217b—Grid

217a, 219a, 223a—Central point

218—Page column

219, 223—Overview coordinates figure

219b, 223b—Line

219c, 223c—Mark

220—Overview refill

221—Total action entry column

222—Refill information entry column

224—Refill page column

225—Beat entry column

226—Memo column

227—Fold

230—Identification entry refill

231—Group name entry column

232—Name entry column

233—Identification number entry column

What is claimed is:

1. A notebook used for the marching bands in which several members take group action with music comprising:
separately refills consists of one or more sheets printed entry columns;
musical piece entry columns for writing down musical pieces, and printed on the separately refills;
action entry columns for writing down shifts of the action with the musical pieces written in the musical piece entry columns, and printed in the same field as the musical piece entry column on the separately refills; and
a holder for holding the separately refills.

2. The notebook for the marching bands as claimed in claim 1 comprising further, an overview refill for printing overview entry columns, in order to combine and to write the shift of the action written to several sheets of the separately refill.

3. The notebook for the marching bands as claimed in claim 1 comprising further a binder part opened and closed as a booklet, wherein
the binder part is opened and closed by the bent part as a pine,
the holder part is arranged at this bent part,
the shoulder strap is connected to the spine removable.

4. The notebook for the marching bands as claimed in claim 1 comprising further, a marking plate as a hard plate removable to the holder part, wherein guide grooves are engraved on the both sides or one side of the hard plate.

5. A design method of the marching band that several members take group action with music comprising:
a step for writing down musical pieces to musical piece entry columns on separately refills,
and for writing down shifts of the action with the musical pieces written in the musical piece entry columns to action entry columns printed in the same field as the musical piece entry column on the separately refills,
a step for holding separately refills to a holder,
a step for posting the sticky tape in order to cross to guide grooves which are engraved on the both sides or one side of a marking plate as a hard plate removable to the holder,
a step for writing down the information about the action written to the separately refills, to the sticky tape on the marking plate according to the guide groove,
a step for making markings by carving the sticky tape on the marking plate along the guide groove, and
a step pointing the marking in according to the shifts of the action written down to the separately refills.
